(19) United States
(12) Patent Application Publication
(10) Pub. No.: US 2025/0242238 A1
(43) Pub. Date: Jul. 31, 2025

(54) STORAGE MEDIUM, IMAGE PROCESSING SYSTEM, IMAGE PROCESSING APPARATUS, AND IMAGE PROCESSING METHOD

(71) Applicant: NINTENDO CO., LTD., Kyoto (JP)

(72) Inventors: Yasuhito FUJISAWA, Kyoto (JP); Taiju MIYAKITA, Kyoto (JP)

(21) Appl. No.: 18/883,112

(22) Filed: Sep. 12, 2024

(30) Foreign Application Priority Data
Jan. 29, 2024 (JP) 2024-011013

(51) Int. Cl. A63F 13/52

(52) U.S. Cl. CPC A63F 13/52

(57) ABSTRACT

In a virtual space, a decal having a set projection position and projection direction is defined, and a blocking object set for the decal is arranged. In a process of rendering the virtual space, for a surface of a projection target related to the projection position and the projection direction, the decal is not projected, or is projected and rendered with a reduced degree of projection, onto a range of the surface that is blocked by the blocking object along the projection direction, and the decal is projected and rendered onto a range of the surface that is not blocked by the blocking object along the projection direction.

### CROSS REFERENCE TO RELATED APPLICATION

This application claims priority to Japanese Patent Application No. 2024-011013, filed on Jan. 29, 2024, the entire contents of which are incorporated herein by reference.

### FIELD

The technology disclosed herein relates to storage media, image processing systems, image processing apparatuses, and image processing methods for performing a rendering process in a virtual space.

### BACKGROUND AND SUMMARY

There has conventionally been a decal process that projects and attaches a design, pattern, or the like onto the surface of an object in a virtual space.

However, there has been a problem with the decal process that a decal may penetrate through an object onto which the decal should be projected to reach a position behind the object along the direction in which the decal is projected.

With the above problem in mind, the present example provides a storage medium, image processing system, image processing apparatus, and image processing method for preventing a decal from penetrating through a portion in a virtual space at which penetration of the decal would cause a problem when the decal is projected.

The present example may have features (1) to (6) below, for example.
(1) A non-transitory computer-readable storage medium according to the present example having stored therein instructions that, when executed, cause one or more processors of an information processing apparatus to execute information processing comprising: defining a decal having a set projection position and projection direction, and arranging a blocking object set for the decal, in a virtual space; and in a process of rendering the virtual space, for a surface of a projection target related to the projection position and the projection direction, avoiding projecting the decal, or projecting and rendering the decal with a reduced degree of projection, onto a range of the surface that is blocked by the blocking object along the projection direction, and projecting and rendering the decal onto a range of the surface that is not blocked by the blocking object along the projection direction.

With the configuration of (1), a blocking object is arranged at a portion through which a decal would otherwise penetrate to cause a trouble, and therefore, the decal can be prevented from penetrating through that position and being then rendered.
(2) In the configuration of (1), further, at least one of the projection position and projection direction of the decal may be dynamically changed in the virtual space.

With the configuration of (2), blocking of a decal can be flexibly set according to a dynamic change in at least one of the projection position and projection direction of the decal in the virtual space, compared to the case in which meshes to which a decal is not applied are masked in conventional masking processes. The present example is suitable for embodiments in which a decal is moved.
(3) In the configuration of (1) or (2), further, at least one of the position and shape of the blocking object is dynamically changed in the virtual space.

With the configuration of (3), blocking of a decal can be flexibly set according to a dynamic change in at least one of the projection and shape of a blocking range in the virtual space, compared to the case in which meshes to which a decal is not applied are masked in conventional masking processes. The present example is suitable for embodiments in which a decal is moved.
(4) In any one of the configurations of (1) to (3), the blocking object may be an object that is not a rendering target.

With the configuration of (4), blocking of a decal can be controlled using an object that does not have an influence on rendering.
(5) In any one of the configurations of (1) to (4), the blocking object may be a planar object.

With the configuration of (5), blocking of a decal can be easily controlled using a planar object.
(6) In the configuration of (5), for the blocking object, a texture including an alpha value may be set. Further, in the process of rendering the virtual space, the decal may be projected and rendered with a projection degree set according to the alpha value of the texture associated with a position on the blocking object that is blocked during the projection.

With the configuration of (6), a decal is projected with a projection degree set according to the alpha value, whereby finer rendering settings can be provided, including smooth rendering of a decal projected onto a portion in the vicinity of a boundary of a blocking range. The present example is particularly suitable for the case in which light or shade is represented by a decal.

In addition, the present example may be carried out in the forms of an image processing system, image processing apparatus, and image processing method.

According to the present example, a decal can be prevented from penetrating through a position through which the decal would otherwise penetrate to cause a trouble.

These and other objects, features, aspects and advantages of the present exemplary embodiment will become more apparent from the following detailed description of the present exemplary embodiment when taken in conjunction with the accompanying drawings.

### BRIEF DESCRIPTION OF THE DRAWINGS

FIG. 1 is a diagram illustrating a non-limiting example of a state in which a left controller 3 and a right controller 4 are attached to a main body apparatus 2,

FIG. 2 is a diagram illustrating a non-limiting example of a state in which a left controller 3 and a right controller 4 are detached from a main body apparatus 2,

FIG. 3 illustrates six orthogonal views of a non-limiting example of a main body apparatus 2,

FIG. 4 illustrates six orthogonal views of a non-limiting example of a left controller 3,

FIG. 5 illustrates six orthogonal views of a non-limiting example of a right controller 4,

FIG. 6 is a block diagram illustrating a non-limiting example of an internal configuration of a main body apparatus 2,

FIG. 7 is a block diagram illustrating non-limiting examples of internal configurations of a main body apparatus 2, a left controller 3, and a right controller 4,

FIG. 8 is a diagram illustrating a non-limiting example of a game image in which a decal is projected and rendered onto objects OBJ1 and OBJ2 in a virtual space,

FIG. 9 is a diagram illustrating a non-limiting example of a blocking object used in a rendering process in which a decal is projected,

FIG. 10 is a diagram illustrating a non-limiting example of a blocking object used in a rendering process in which a decal is projected,

FIG. 11 is a diagram illustrating a non-limiting example of a blocking object used in a rendering process in which a decal is projected,

FIG. 12 is a diagram illustrating a non-limiting example in which a decal is projected in a tilted projection direction,

FIG. 13 is a diagram illustrating a non-limiting example of a data area set in a DRAM 85 of a main body apparatus 2,

FIG. 14 is a flowchart illustrating a non-limiting example of a game process that is executed in a game system 1, and

FIG. 15 is a subroutine illustrating a non-limiting example of a decal process in step S126 of FIG. 14.

### DETAILED DESCRIPTION OF NON-LIMITING EXAMPLE EMBODIMENTS

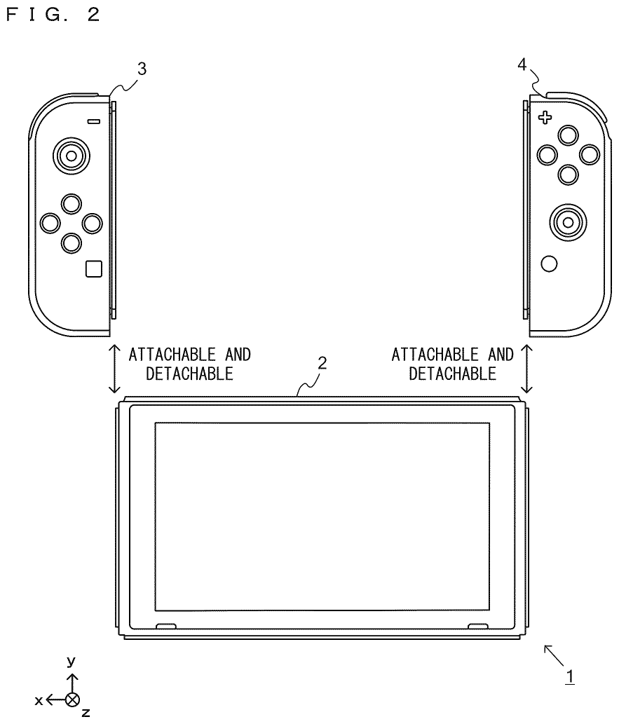

An image processing system according to the present example will now be described. A game system 1 that is an example of the image processing system according to the present example includes a main body apparatus (information processing apparatus serving as the main body of a game apparatus in the present example) 2, a left controller 3, and a right controller 4. The left controller 3 and the right controller 4 are attachable to and detachable from the main body apparatus 2. That is, the user can attach the left controller 3 and the right controller 4 to the main body apparatus 2, and use them as a unified apparatus. The user can also use the main body apparatus 2 and the left controller 3 and the right controller 4 separately from each other (see FIG. 2). In the following description, a hardware configuration of the game system 1 of the present example is described, and thereafter, the control of the game system 1 of the present example is described.

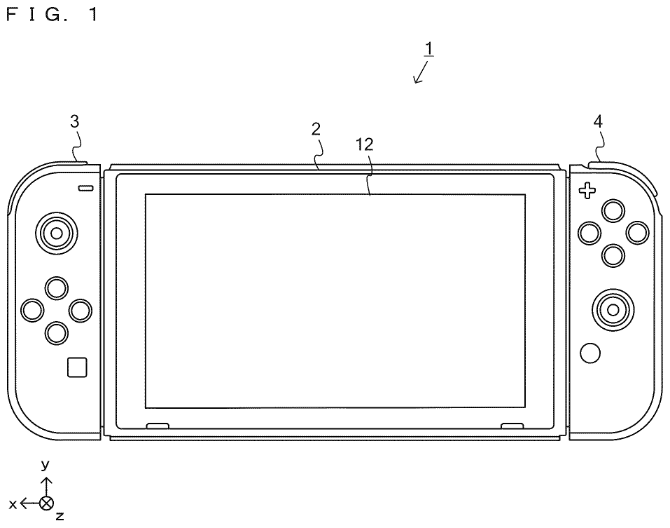

FIG. 1 is a diagram illustrating an example of a state in which the left controller 3 and the right controller 4 are attached to the main body apparatus 2. As illustrated in FIG. 1, each of the left controller 3 and the right controller 4 is attached to and unified with the main body apparatus 2. The main body apparatus 2 is an apparatus for performing various processes (e.g., game processing) in the game system 1. The main body apparatus 2 includes a display 12. Each of the left controller 3 and the right controller 4 is an apparatus including operation sections with which a user provides inputs.

FIG. 2 is a diagram illustrating an example of a state in which each of the left controller 3 and the right controller 4 is detached from the main body apparatus 2. As illustrated in FIGS. 1 and 2, the left controller 3 and the right controller 4 are attachable to and detachable from the main body apparatus 2. It should be noted that hereinafter, the left controller 3 and the right controller 4 will occasionally be referred to collectively as a “controller”.

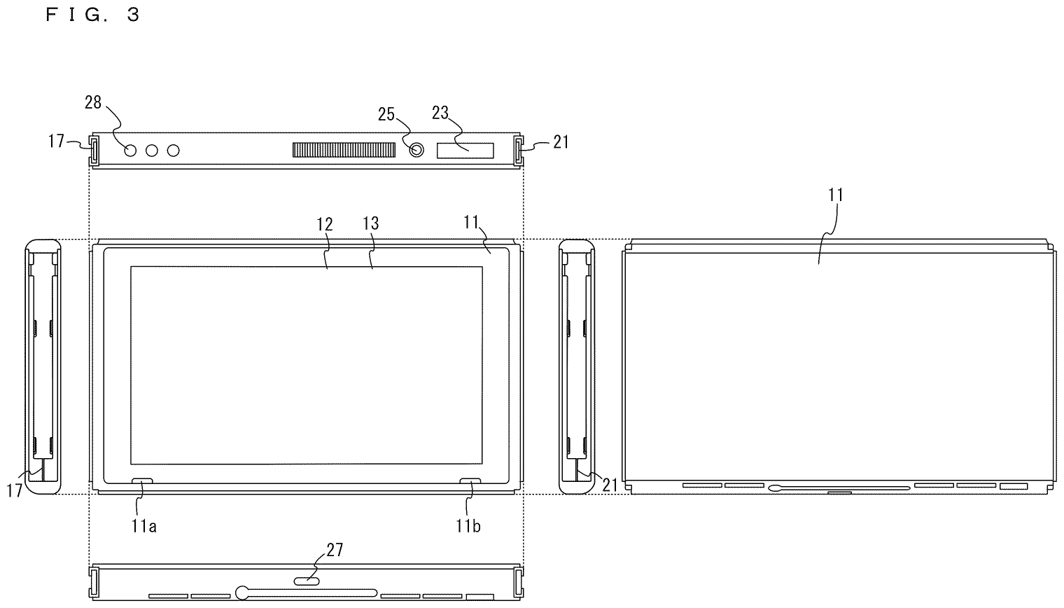

FIG. 3 illustrates six orthogonal views of an example of the main body apparatus 2. As illustrated in FIG. 3, the main body apparatus 2 includes an approximately plate-shaped housing 11. In the present example, a main surface (in other words, a surface on a front side, i.e., a surface on which the display 12 is provided) of the housing 11 has a generally rectangular shape.

It should be noted that the shape and the size of the housing 11 are optional. As an example, the housing 11 may be of a portable size. Further, the main body apparatus 2 alone or the unified apparatus obtained by attaching the left controller 3 and the right controller 4 to the main body apparatus 2 may function as a mobile apparatus. The main body apparatus 2 or the unified apparatus may function as a handheld apparatus or a portable apparatus.

As illustrated in FIG. 3, the main body apparatus 2 includes the display 12, which is provided on the main surface of the housing 11. The display 12 displays an image generated by the main body apparatus 2. In the present example, the display 12 is a liquid crystal display device (LCD). The display 12, however, may be a display device of any suitable type.

In addition, the main body apparatus 2 includes a touch panel 13 on the screen of the display 12. In the present example, the touch panel 13 allows multi-touch input (e.g., a capacitive touch panel). It should be noted that the touch panel 13 may be of any suitable type, e.g., it allows single-touch input (e.g., a resistive touch panel).

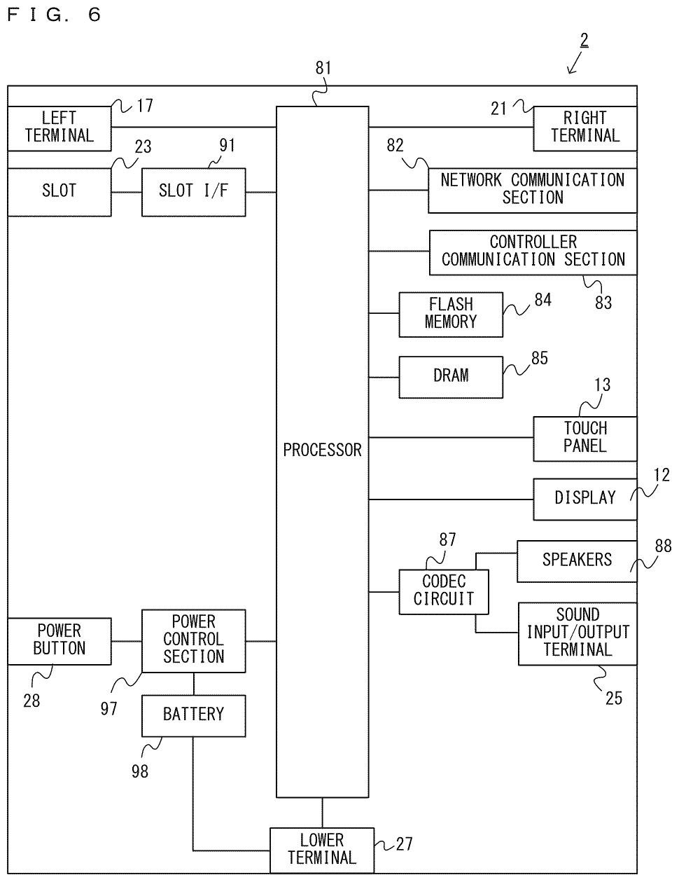

The main body apparatus 2 includes a speaker (i.e., a speaker 88 illustrated in FIG. 6) inside the housing 11. As illustrated in FIG. 3, speaker holes 11a and 11b are formed in the main surface of the housing 11. The speaker 88 outputs sounds through the speaker holes 11a and 11b.

The main body apparatus 2 also includes a left-side terminal 17 that enables wired communication between the main body apparatus 2 and the left controller 3, and a right-side terminal 21 that enables wired communication between the main body apparatus 2 and the right controller 4.

As illustrated in FIG. 3, the main body apparatus 2 includes a slot 23. The slot 23 is provided on an upper side surface of the housing 11. The slot 23 is so shaped as to allow a predetermined type of storage medium to be attached to the slot 23. The predetermined type of storage medium is, for example, a dedicated storage medium (e.g., a dedicated memory card) for the game system 1 and an information processing apparatus of the same type as the game system 1. The predetermined type of storage medium is used to store, for example, data (e.g., saved data of an application or the like) used by the main body apparatus 2 and/or a program (e.g., a program for an application or the like) executed by the main body apparatus 2. Further, the main body apparatus 2 includes a power button 28.

The main body apparatus 2 includes a lower-side terminal 27. The lower-side terminal 27 allows the main body apparatus 2 to communicate with a cradle. In the present example, the lower-side terminal 27 is a USB connector (more specifically, a female connector). When the unified apparatus or the main body apparatus 2 alone is placed on the cradle, the game system 1 can display, on a stationary monitor, an image that is generated and output by the main body apparatus 2. Also, in the present example, the cradle has the function of charging the unified apparatus or the main body apparatus 2 alone, being placed thereon. The cradle also functions as a hub device (specifically, a USB hub).

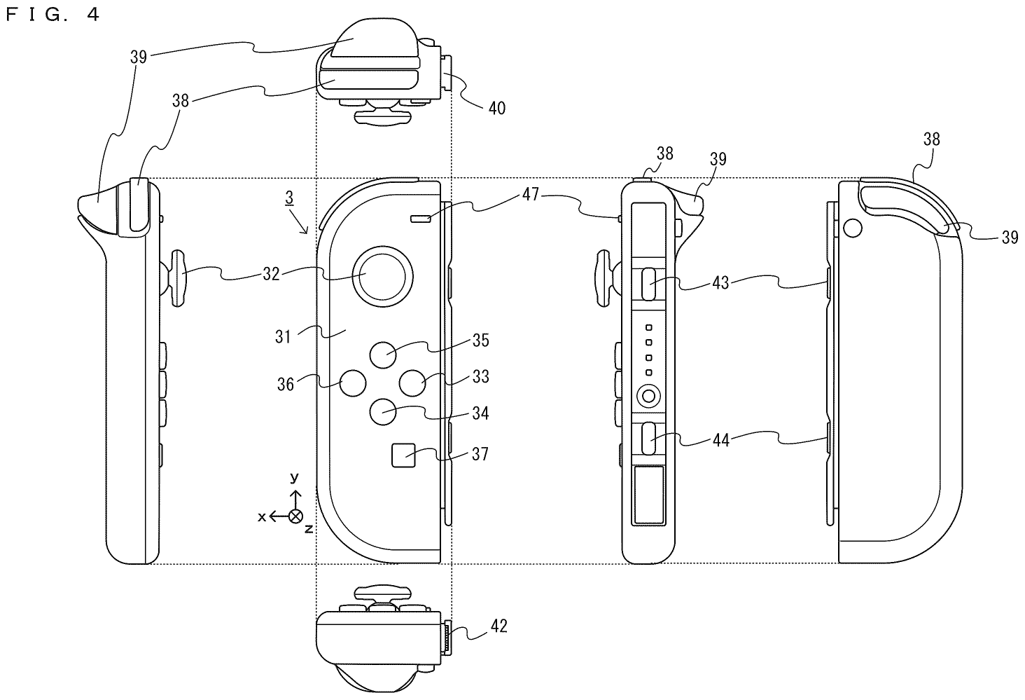

FIG. 4 illustrates six orthogonal views of an example of the left controller 3. As illustrated in FIG. 4, the left controller 3 includes a housing 31. In the present example, the housing 31 has a vertically long shape, e.g., is shaped to be long in an up-down direction (i.e., a y-axis direction illustrated in FIGS. 1 and 4). In the state in which the left controller 3 is detached from the main body apparatus 2, the left controller 3 can also be held in the orientation in which the left controller 3 is vertically long. The housing 31 has such a shape and a size that when held in the orientation in which the housing 31 is vertically long, the housing 31 can be held with one hand, particularly the left hand. Further, the left controller 3 can also be held in the orientation in which the left controller 3 is horizontally long. When held in the orientation in which the left controller 3 is horizontally long, the left controller 3 may be held with both hands.

The left controller 3 includes an analog stick 32. As illustrated in FIG. 4, the analog stick 32 is provided on a main surface of the housing 31. The analog stick 32 can be used as a direction input section with which a direction can be input. The user tilts the analog stick 32 and thereby can input a direction corresponding to the direction of the tilt (and input a magnitude corresponding to the angle of the tilt). It should be noted that the left controller 3 may include a directional pad, a slide stick that allows a slide input, or the like as the direction input section, instead of the analog stick. Further, in the present example, it is possible to provide an input by pressing the analog stick 32.

The left controller 3 includes various operation buttons. The left controller 3 includes four operation buttons 33 to 36 (specifically, a right direction button 33, a down direction button 34, an up direction button 35, and a left direction button 36) on the main surface of the housing 31. Further, the left controller 3 includes a record button 37 and a “−” (minus) button 47. The left controller 3 includes a first L-button 38 and a ZL-button 39 in an upper left portion of a side surface of the housing 31. Further, the left controller 3 includes a second L-button 43 and a second R-button 44, on the side surface of the housing 31 on which the left controller 3 is attached to the main body apparatus 2. These operation buttons are used to give commands depending on various programs (e.g., an OS program and an application program) executed by the main body apparatus 2.

The left controller 3 also includes a terminal 42 that enables wired communication between the left controller 3 and the main body apparatus 2.

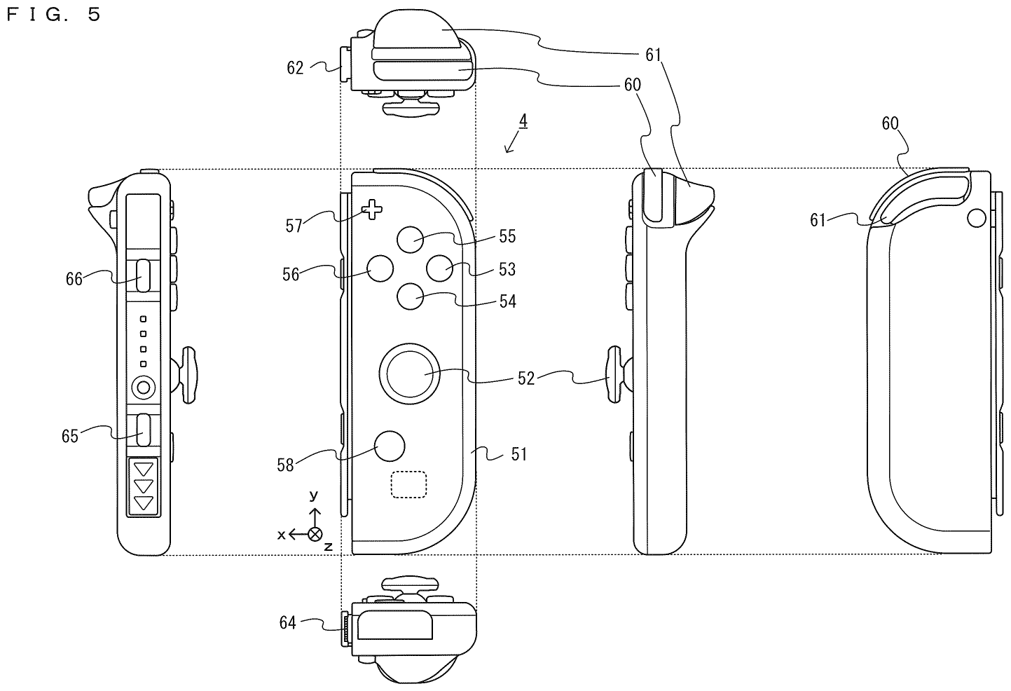

FIG. 5 illustrates six orthogonal views of an example of the right controller 4. As illustrated in FIG. 5, the right controller 4 includes a housing 51. In the present example, the housing 51 has a vertically long shape, e.g., is shaped to be long in the up-down direction. In the state in which the right controller 4 is detached from the main body apparatus 2, the right controller 4 can also be held in the orientation in which the right controller 4 is vertically long. The housing 51 has such a shape and a size that when held in the orientation in which the housing 51 is vertically long, the housing 51 can be held with one hand, particularly the right hand. Further, the right controller 4 can also be held in the orientation in which the right controller 4 is horizontally long. When held in the orientation in which the right controller 4 is horizontally long, the right controller 4 may be held with both hands.

Similarly to the left controller 3, the right controller 4 includes an analog stick 52 as a direction input section. In the present example, the analog stick 52 has the same configuration as that of the analog stick 32 of the left controller 3. Further, the right controller 4 may include a directional pad, a slide stick that allows a slide input, or the like, instead of the analog stick. Further, similarly to the left controller 3, the right controller 4 includes four operation buttons 53 to 56 (specifically, an A-button 53, a B-button 54, an X-button 55, and a Y-button 56) on a main surface of the housing 51. Further, the right controller 4 includes a “+” (plus) button 57 and a home button 58. Further, the right controller 4 includes a first R-button 60 and a ZR-button 61 in an upper right portion of a side surface of the housing 51. Further, similarly to the left controller 3, the right controller 4 includes a second L-button 65 and a second R-button 66.

Further, the right controller 4 includes a terminal 64 for allowing the right controller 4 to perform wired communication with the main body apparatus 2.

FIG. 6 is a block diagram illustrating an example of an internal configuration of the main body apparatus 2. The main body apparatus 2 includes components 81 to 91, 97, and 98 illustrated in FIG. 6 in addition to the components illustrated in FIG. 3. Some of the components 81 to 91, 97, and 98 may be implemented as electronic parts on an electronic circuit board, which is contained in the housing 11.

The main body apparatus 2 includes a processor 81. The processor 81 is an information processor for executing various types of information processing to be executed by the main body apparatus 2. For example, the CPU 81 may include only a central processing unit (CPU), or may be a system-on-a-chip (SoC) having a plurality of functions such as a CPU function and a graphics processing unit (GPU) function. The processor 81 executes an information processing program (e.g., a game program) stored in a storage section (specifically, an internal storage medium such as a flash memory 84, an external storage medium that is attached to the slot 23, or the like), thereby executing the various types of information processing.

The main body apparatus 2 includes a flash memory 84 and a dynamic random access memory (DRAM) 85 as examples of internal storage media built in itself. The flash memory 84 and the DRAM 85 are connected to the CPU 81. The flash memory 84 is mainly used to store various data (or programs) to be saved in the main body apparatus 2. The DRAM 85 is used to temporarily store various data used in information processing.

The main body apparatus 2 includes a slot interface (hereinafter abbreviated to “I/F”) 91. The slot I/F 91 is connected to the processor 81. The slot I/F 91 is connected to the slot 23, and reads and writes data from and to a predetermined type of storage medium (e.g., a dedicated memory card) attached to the slot 23, in accordance with commands from the processor 81.

The processor 81 reads and writes, as appropriate, data from and to the flash memory 84, the DRAM 85, and each of the above storage media, thereby executing the above information processing.

The main body apparatus 2 includes a network communication section 82. The network communication section 82 is connected to the processor 81. The network communication section 82 communicates (specifically, through wireless communication) with an external apparatus via a network. In the present example, as a first communication form, the network communication section 82 connects to a wireless LAN and communicates with an external apparatus, using a method compliant with the Wi-Fi standard. Further, as a second communication form, the network communication section 82 wirelessly communicates with another main body apparatus 2 of the same type, using a predetermined communication method (e.g., communication based on a particular protocol or infrared light communication). It should be noted that the wireless communication in the above second communication form achieves the function of allowing so-called “local communication”, in which the main body apparatus 2 can wirelessly communicate with another main body apparatus 2 located in a closed local network area, and the plurality of main body apparatuses 2 directly communicate with each other to exchange data.

The main body apparatus 2 includes a controller communication section 83. The controller communication section 83 is connected to the processor 81. The controller communication section 83 wirelessly communicates with the left controller 3 and/or the right controller 4. The main body apparatus 2 may communicate with the left and right controllers 3 and 4 using any suitable communication method. In the present example, the controller communication section 83 performs communication with the left and right controllers 3 and 4 in accordance with the Bluetooth (registered trademark) standard.

The processor 81 is connected to the left-side terminal 17, the right-side terminal 21, and the lower-side terminal 27. When performing wired communication with the left controller 3, the processor 81 transmits data to the left controller 3 via the left-side terminal 17 and also receives operation data from the left controller 3 via the left-side terminal 17. Further, when performing wired communication with the right controller 4, the processor 81 transmits data to the right controller 4 via the right-side terminal 21 and also receives operation data from the right controller 4 via the right-side terminal 21. Further, when communicating with the cradle, the processor 81 transmits data to the cradle via the lower-side terminal 27. As described above, in the present example, the main body apparatus 2 can perform both wired communication and wireless communication with each of the left and right controllers 3 and 4. Further, when the unified apparatus obtained by attaching the left and right controllers 3 and 4 to the main body apparatus 2 or the main body apparatus 2 alone is attached to the cradle, the main body apparatus 2 can output data (e.g., image data or sound data) to a stationary monitor or the like via the cradle.

Here, the main body apparatus 2 can communicate with a plurality of left controllers 3 simultaneously (or in parallel). Further, the main body apparatus 2 can communicate with a plurality of right controllers 4 simultaneously (or in parallel). Thus, a plurality of users can simultaneously provide inputs to the main body apparatus 2, each using a set of left and right controllers 3 and 4. As an example, a first user can provide an input to the main body apparatus 2 using a first set of left and right controllers 3 and 4, and at the same time, a second user can provide an input to the main body apparatus 2 using a second set of left and right controllers 3 and 4.

Further, the display 12 is connected to the processor 81. The processor 81 displays, on the display 12, a generated image (e.g., an image generated by executing the above information processing) and/or an externally obtained image.

The main body apparatus 2 includes a codec circuit 87 and speakers (specifically, a left speaker and a right speaker) 88. The codec circuit 87 is connected to the speakers 88 and an audio input/output terminal 25 and also connected to the processor 81. The codec circuit 87 is for controlling the input and output of audio data to and from the speakers 88 and the sound input/output terminal 25.

The main body apparatus 2 includes a power control section 97 and a battery 98. The power control section 97 is connected to the battery 98 and the processor 81. Further, although not illustrated, the power control section 97 is connected to components of the main body apparatus 2 (specifically, components that receive power supplied from the battery 98, the left-side terminal 17, and the right-side terminal 21). Based on a command from the processor 81, the power control section 97 controls the supply of power from the battery 98 to each of the above components.

Further, the battery 98 is connected to the lower-side terminal 27. When an external charging device (e.g., the cradle) is connected to the lower-side terminal 27, and power is supplied to the main body apparatus 2 via the lower-side terminal 27, the battery 98 is charged with the supplied power.

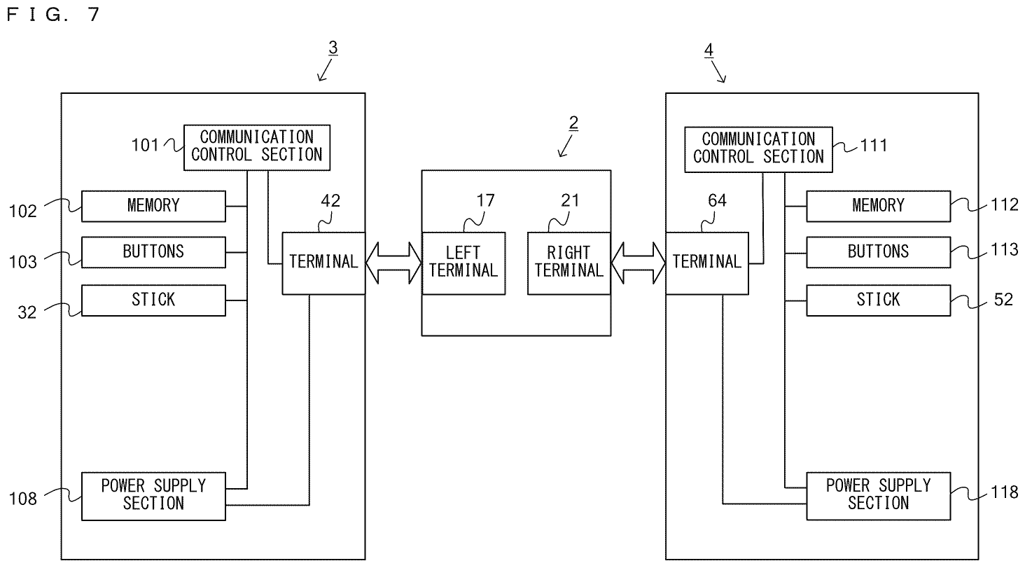

FIG. 7 is a block diagram illustrating examples of the internal configurations of the main body apparatus 2, the left controller 3, and the right controller 4. It should be noted that the details of the internal configuration of the main body apparatus 2 are illustrated in FIG. 6 and therefore are omitted in FIG. 7.

The left controller 3 includes a communication control section 101, which communicates with the main body apparatus 2. As illustrated in FIG. 7, the communication control section 101 is connected to components including the terminal 42. In the present example, the communication control section 101 can communicate with the main body apparatus 2 through both wired communication via the terminal 42 and wireless communication without via the terminal 42. The communication control section 101 controls the method for communication performed by the left controller 3 with the main body apparatus 2. That is, when the left controller 3 is attached to the main body apparatus 2, the communication control section 101 communicates with the main body apparatus 2 via the terminal 42. Further, when the left controller 3 is detached from the main body apparatus 2, the communication control section 101 wirelessly communicates with the main body apparatus 2 (specifically, the controller communication section 83). The wireless communication between the communication control section 101 and the controller communication section 83 is performed in accordance with the Bluetooth (registered trademark) standard, for example.

Further, the left controller 3 includes a memory 102 such as a flash memory. The communication control section 101 includes, for example, a microcomputer (or a microprocessor) and executes firmware stored in the memory 102, thereby performing various processes.

The left controller 3 includes buttons 103 (specifically, the buttons 33 to 39, 43, 44, and 47). Further, the left controller 3 includes the analog stick (“stick” in FIG. 7) 32. Each of the buttons 103 and the analog stick 32 outputs information regarding an operation performed on itself to the communication control section 101 repeatedly at appropriate timing.

The communication control section 101 obtains information regarding an input (specifically, information regarding an operation or the detection result of the sensor) from each of input sections (specifically, the buttons 103 and the analog stick 32). The communication control section 101 transmits operation data including the obtained information (or information obtained by performing predetermined processing on the obtained information) to the main body apparatus 2. It should be noted that the operation data is transmitted repeatedly, once every predetermined time. It should be noted that the interval at which the information regarding an input is transmitted from each of the input sections to the main body apparatus 2 may or may not be the same.

The above operation data is transmitted to the main body apparatus 2, whereby the main body apparatus 2 can obtain inputs provided to the left controller 3. That is, the main body apparatus 2 can determine operations on the buttons 103 and the analog stick 32 based on the operation data.

The left controller 3 includes a power supply section 108. In the present example, the power supply section 108 includes a battery and a power control circuit. Although not illustrated in FIG. 7, the power control circuit is connected to the battery and also connected to components of the left controller 3 (specifically, components that receive power supplied from the battery).

As illustrated in FIG. 7, the right controller 4 includes a communication control section 111, which communicates with the main body apparatus 2. Further, the right controller 4 includes a memory 112, which is connected to the communication control section 111. The communication control section 111 is connected to components including the terminal 64. The communication control section 111 and the memory 112 have functions similar to those of the communication control section 101 and the memory 102, respectively, of the left controller 3. Thus, a communication control section 111 can communicate with the main body apparatus 2 through both wired communication via the terminal 64 and wireless communication without via the terminal 64 (specifically, communication compliant with the Bluetooth (registered trademark) standard). The communication control section 111 controls the method for communication performed by the right controller 4 with the main body apparatus 2.

The right controller 4 includes input sections similar to the input sections of the left controller 3. Specifically, the right controller 4 includes buttons 113, and the analog stick 52. These input sections have functions similar to those of the input sections of the left controller 3 and operate similarly to the input sections of the left controller 3.

The right controller 4 includes a power supply section 118. The power supply section 118 has a function similar to that of the power supply section 108 of the left controller 3 and operates similarly to the power supply section 108.

As described above, in the game system 1 of the present example, the left controller 3 and the right controller 4 are removable from the main body apparatus 2. In addition, when the unified apparatus obtained by attaching the left controller 3 and the right controller 4 to the main body apparatus 2 or the main body apparatus 2 alone is attached to the cradle, an image (and sound) can be output on an external display device, such as a stationary monitor or the like. The game system 1 will be described below according to an embodiment in which an image is displayed on the display 12. It should be noted that in the case in which the game system 1 is used in an embodiment in which an image is displayed on the display 12, the game system 1 may be used with the left controller 3 and the right controller 4 attached to the main body apparatus 2 (e.g., the main body apparatus 2, the left controller 3, and the right controller 4 are integrated in a single housing).

A game is played using a virtual space displayed on the display 12, according to operations performed on the operation buttons and sticks of the left controller 3 and/or the right controller 4, or touch operations performed on the touch panel 13 of the main body apparatus 2, in the game system 1. In the present example, as an example, a rendering process is performed in a virtual space based on a game process according to the user's operation performed using the operation buttons and sticks.

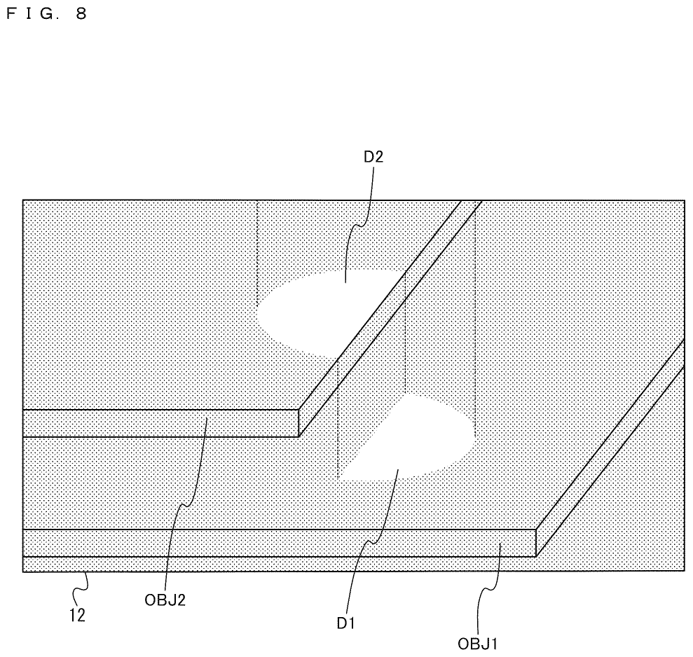

An example image process for performing rendering in a virtual space will be outlined with reference to FIG. 8. In the image process of the present example, a decal process of projecting a decal onto a projection target is used.

In FIG. 8, an image in which a plate-shaped object OBJ1 and a plate-shaped object OBJ2 are vertically arranged in a virtual space is displayed on the display 12. The object OBJ1 forms a lower-stage horizontal surface in the virtual space. The object OBJ2 forms an upper-stage horizontal surface in the virtual space, and is arranged above and at a predetermined distance away from the upper surface of the object OBJ1. The object OBJ2 is arranged so as to overlap or partially cover the object OBJ1 as viewed in the vertical direction. Specifically, the object OBJ1 has a portion covered by the object OBJ2 from above, and a portion (non-covered portion) above which the object OBJ2 is not arranged and is therefore open upward.

In such a rendering process in a virtual space, a decal is projected and rendered in the virtual space. In the present example, in order to attach a picture or pattern to a portion of the surfaces of the object OBJ1 and the object OBJ2, a decal showing the picture or pattern is defined and projected in the virtual space, so that the picture or pattern is rendered on the surfaces (texture) of the object OBJ1 and the object OBJ2. For example, in the present example, the rendering process in a virtual space is applied to a decal that is dynamically projected in the virtual space, so that light, shade, or the like on the surface of an object is represented by a decal. In another example, marks (sighting devices of guns and the like, marks indicating destinations of movements of characters, displays indicating attack influence ranges, and the like) as game UIs are represented by a decal.

In an example image of a virtual space illustrated in FIG. 8, light illuminating a portion of a lightly dark virtual space is represented by a decal. For example, a decal is defined above the object OBJ1 and the object OBJ2, where the vertical direction of the virtual space is the projection direction of the decal. In addition, in the example illustrated in FIG. 8, the projection position of the decal is set such that a portion of the decal is projected onto the object OBJ2 while the other portion of the decal is projected onto the object OBJ1, but not to the object OBJ2. As a result, a decal D2 that is a portion of the decal is projected onto the upper surface of the upper object OBJ2 while a decal D1 that is the other portion of the decal is projected onto the upper surface of the lower object OBJ1.

Here, the decal is rendered on an object surface that is opposite the decal in the projection direction. If the object surface is positioned within the projection range (projection box described below) of the decal, then even when the object surface is blocked by another object due to a multiplex structure, the decal penetrates through the blocking object and is rendered on the object surface. Decals have such a nature. For example, in the example illustrated in FIG. 8 in which a decal is projected in a virtual space, the decal D2 projected onto the upper surface of the object OBJ2 has a nature that the decal D2 penetrates through the object OBJ2 along the projection direction of the decal, and is also projected and rendered onto the upper surface of the object OBJ1.

In the present example, a blocking object set for the decal is arranged between the object OBJ1 and the object OBJ2 (e.g., in a space between the separate objects), thereby preventing the decal D2 from being projected onto the object OBJ1. In the present example, blocking objects are an object that is not a rendering target. For blocking objects, a range within which a corresponding decal is blocked, a range within which a corresponding decal is not blocked, and a range within which the degree of projection of a corresponding decal is reduced are set. A decal is not projected onto a range of the upper surface of the object OBJ1 within which the decal is to be projected according to the projection position and projection direction of the decal and that is blocked by the range within which the object is blocked by the blocking object. Therefore, in the present example, by providing a range within which the decal D2 is blocked by a blocking object so as to cover a range within which the decal D2 would otherwise penetrate through the object OBJ2, the decal D1 that is a portion of the defined decal is projected and rendered even onto a projection target onto which the decal is to be projected as illustrated in FIG. 8 without the decal D2 being projected onto the upper surface of the object OBJ1.

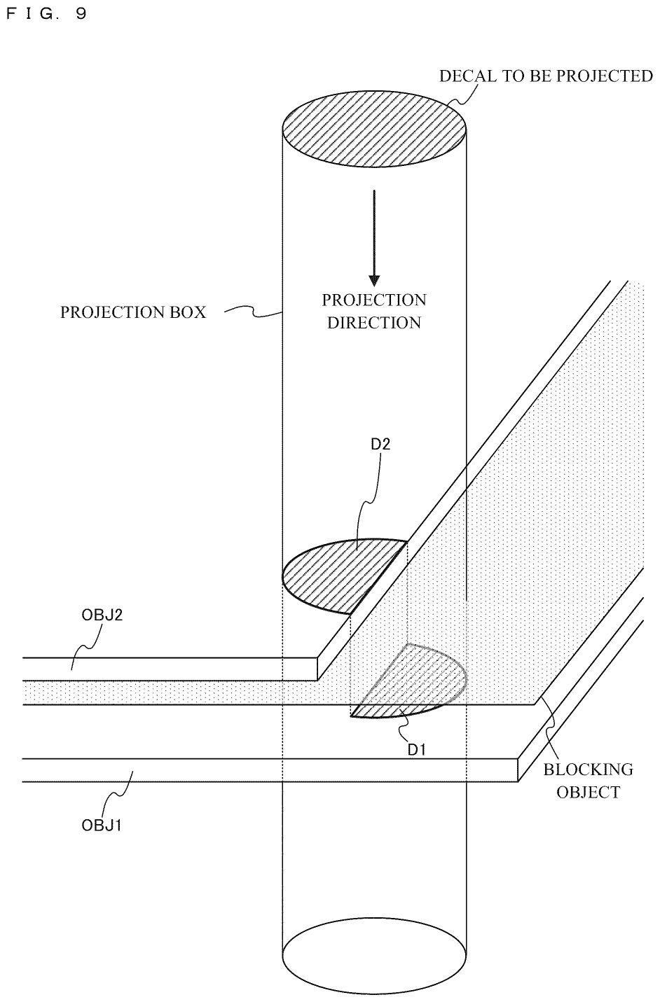

Next, an example blocking object that is used in the rendering process in a virtual space illustrated in FIG. 8 will be described with reference to FIGS. 9 to 11.

As illustrated in FIG. 9, in the present example, a decal whose projection direction and projection position are set is defined in a virtual space. In addition, a projection box that is formed in the shape of a box generated by the defined decal moving in the projection direction by a predetermined projection distance is set in the virtual space. For example, in the present example, an example in which a decal is subjected to parallel projection and rendered in a virtual space is used, and therefore, the projection box has the shape of a cylinder, elliptic cylinder, prism, or the like generated by the defined decal translating by the projection distance. The projection box is a range for determining whether or not a decal for which the projection box is set is to be applied. If a pixel included in a surface opposite the projection direction is within the projection box, the pixel is determined as a projection target pixel onto which the decal is to be projected. For example, the projection position of the decal illustrated in FIG. 9 is set above the object OBJ1 and the object OBJ2 in the virtual space, and the projection direction thereof is set to the vertical direction. In this case, the upper surfaces of the objects OBJ1 and OBJ2 are opposite the projection direction, and portions of the upper surfaces including pixels within the projection box are a surface onto which the decal is to be projected.

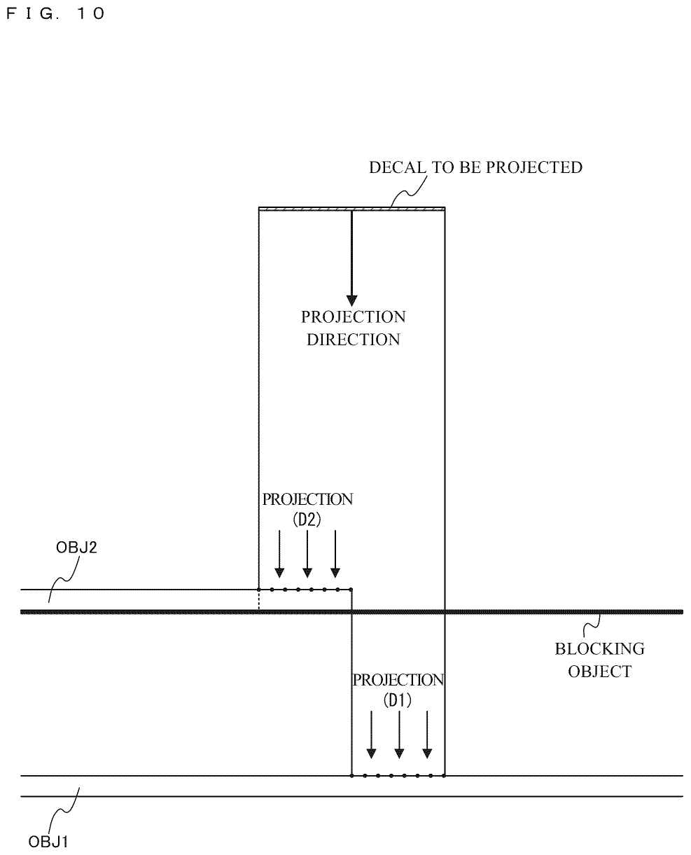

As illustrated in FIGS. 9 and 10, for example, a planar object is used as a blocking object for a decal thus defined. A blocking object is arranged on the front side, in the projection direction of a decal, with respect to the surface (upper surface) of the object OBJ1 onto which projection of at least a portion of a decal (in the present example, the decal D2) is blocked, and the other portion of the decal (in the present example, the decal D1) is projected and rendered. The blocking object is also arranged on the back side, in the projection direction of the decal, with respect to the surface (upper surface) of the object OBJ2 onto which the decal is rendered without the projection thereof being blocked. In other words, the blocking object is arranged between the surfaces of the object OB1 and the object OBJ2 onto which the decal is projected (in the present example, the respective upper surfaces). More preferably, the blocking object is arranged in a space that separates the object OBJ1 and the object OBJ2 and closer to the object OBJ2, and is horizontally arranged, extending along the surface (lower surface) on the back side in the projection direction of the object OBJ2 (typically, the blocking object is in contact with the lower surface of the object OBJ2 without a gap). As a result, even in the case in which another object is arranged in a space that separates the object OBJ1 and the object OBJ2, rendering can be performed while the above blocking of decal projection is applied to the another object. Here, in the present example, the “front side” and the “back side” with respect to an object onto which a decal is to be projected refer to the side on which a position at which projection of the decal is started along the projection direction of the decal is located (the side that is viewed from the decal start position), and the opposite side of the object along the projection direction (the side that is not viewed from the decal start position).

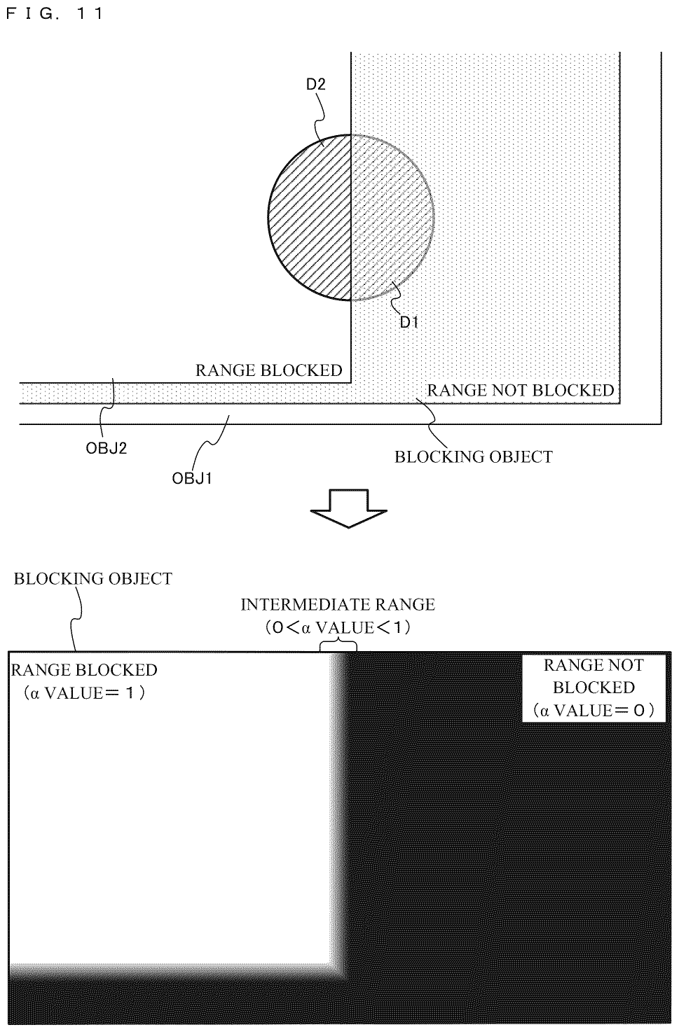

As illustrated in FIG. 11, for a blocking object, a texture including an α value indicated by a numerical value of, for example, 0 to 1 is set. Here, the α value indicates the projection degree of a projected decal. A smaller α value indicates a greater degree of projection of a decal. In the present example, a texture for which the α value=1 is set is set for a range of the blocking object within which a decal is not projected and is blocked (in FIG. 11, indicated by a white region). In addition, a texture for which the α value=0 is set is set for a range of the blocking object within which a decal is projected and is not blocked (in FIG. 11, indicated by a black region). In addition, a texture for which 0<the α value<1 is set is set for an intermediate range of the blocking object within which a decal is projected with a reduced projection degree (in FIG. 11, indicated by a gray region). For example, in the case in which a blocking object that blocks the decal D2 is set, a texture for which the α value=1 is set for a range of the blocking object that is covered by the object OBJ2, and a texture for which the α value=0 is set for a range of the blocking object that is not covered by the object OBJ2. In addition, a texture having the intermediate range is set for a range of the blocking object that is covered by a portion in the vicinity of an end of the object OBJ2. In other words, the intermediate range is set in the vicinity of a boundary between the range within which a decal is blocked with the α value=1 and the range within which a decal is not blocked with the α value=0. It should be noted that, in the intermediate range, the α value may be set such that the α value gradually increases from 0 to 1 as one approaches the range within which a decal is blocked. As a result, rendering can be performed with finer settings. For example, a decal is smoothly rendered at a boundary between a portion in which the decal is projected and a portion in which the decal is blocked. As an example, the present example is particularly suitable for the case in which light or shade is represented by a decal.

In the present example, a post-process of projecting and rendering a decal using the blocking object is applied. In the present example, the projection box is used to determine whether or not each of pixels at which a virtual space is rendered is within a range to which a decal is applied. For pixels in the projection box, an intersection point between a vector in the projection direction and a blocking object corresponding to the decal is then calculated. The a value information of a texture at the intersection point is retrieved, and a rendering process in which the decal is projected onto the pixel with a projection degree corresponding to the α value information is performed. For example, when the α value at the intersection point is 0, i.e., the intersection point is within the range of the blocking object within which a decal is not blocked, a decal having an application percentage of 100% is applied and projected onto a pixel of interest. When the α value at the intersection point is 1, i.e., the intersection point is within the range of the blocking object within which a decal is blocked, rendering of projecting a decal onto a pixel of interest is not performed. When the α value of the intersection point is 0<the α value<1, i.e., the intersection point is within the intermediate range of the blocking object, a decal having an application percentage corresponding to the α value of the intersection point is applied and projected onto a pixel of interest.

It should be noted that the rendering process in which a decal is projected while using a blocking object may not be performed by the post-process. For example, in another example, a process of determining the application percentage of a decal may be performed when a virtual space is rendered, and the virtual space onto which a decal is projected based on the application percentage may be rendered on a pixel-by-pixel basis.

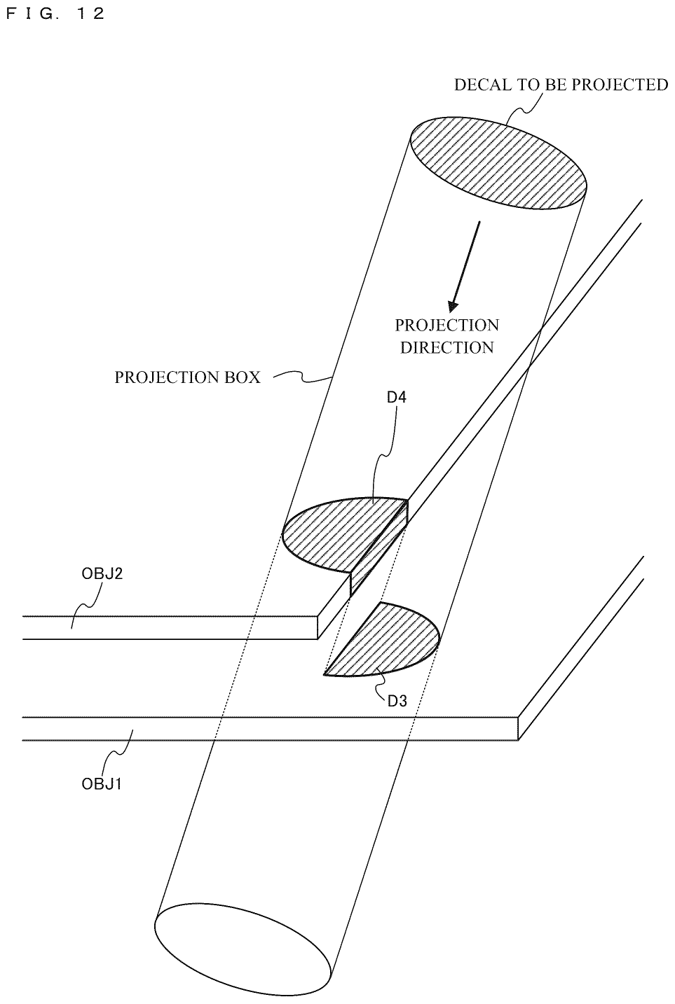

The decal process of the present example is suitable for the case in which a decal is dynamically projected in a virtual space, a dynamic object is used as a projection target, and the like. For example, a decal defined in a virtual space may dynamically change in the virtual space based on a game process. As an example, the projection position and/or projection direction of a decal may dynamically change based on a game process. As illustrated in FIG. 12, by dynamically changing the projection position and projection direction of a decal, the projection direction may be changed and tilted with respect to the vertical direction of a virtual space. In this case, the blocking object is maintained. Specifically, the arrangement and position described in FIGS. 9 to 11 of the blocking object having the set texture described in FIG. 11 are maintained.

When the projection direction of a decal is thus changed and tilted, it is determined whether or not each pixel rendered in a virtual space is within the application range of the decal, using a projection box corresponding to the tilt of the projection direction. Specifically, as illustrated in FIG. 12, a projection box in the shape of a box generated by a defined decal moving in the tilted projection direction by a predetermined projection distance is set in a virtual space. As in the above process of determining the application percentage of a decal, an intersection point between a vector in the tilted projection direction and the blocking object whose position and orientation are maintained is calculated for each pixel in the projection box, the α value information of a texture at the intersection point is retrieved, and a rendering process in which the decal is projected onto the pixel with the projection degree corresponding to the α value information is performed. By such a process of determining the application percentage, a decal D4 is projected and rendered, without being blocked by the blocking object, onto the upper and side surfaces of the object OBJ2, onto which the decal is diagonally projected. In addition, a decal D3 excluding a portion blocked by the blocking object is projected and rendered onto the upper surface of the object OBJ1, onto which the decal is diagonally projected. As can be seen from FIG. 12, the decal D3 projected onto the upper surface of the object OBJ1 is projected and rendered deep inside a space below the object OBJ2, compared to the decal D1, due to the tilted projection direction of the decal. However, by using the blocking of the blocking object, the rendering can be implemented with a simple process only by changing the projection position and projection direction of the decal without moving the blocking object.

For example, in the case in which a conventional masking process is used, when a decal is projected onto the object OBJ1, then if a portion of the meshes of the upper surface of the object OBJ1 onto which the decal is not applied are masked, meshes to which the decal is applied are controlled. In that case, it is necessary to separate a region to which a decal is applied and a region to which the decal is not applied, using meshes. In such a masking process, it is necessary to control the presence or absence of application of a decal on the surface (upper surface) of the object OBJ1 to which the decal is projected. Therefore, it is necessary to change the process of dividing a projection target into meshes each time the projection position is changed, for example, from the decal D1 to the decal D3, resulting in excessive processing load. As described above, the states of the blocking objects of the present example can be maintained even when the projection position and/or projection direction of a decal are dynamically changed. Therefore, processing load is reduced compared to conventional masking processes, and flexible blocking can be set according to various decal dynamic changes.

In addition, the above blocking object may be dynamically changed in a virtual space based on a game process. As an example, the position, pose, and/or shape of a blocking object may be dynamically changed based on a game process. For example, in the case in which the position, pose, and/or shape of the object OBJ2 illustrated in FIGS. 8 to 12 are dynamically changed based on a game process in the virtual space, the position, pose, and/or shape of the blocking object may be similarly changed in association with the change of the object OBJ2 while the same positional relationship is maintained. Thus, even when the area in which the decal D2 is projected onto the object OBJ2 is increased or decreased due to the dynamic change in the position, pose, and/or shape of the object OBJ2, the blocking object is also dynamically changed while the positional relationship between the blocking object and the object OBJ2 is maintained. As a result, the decal D2 is blocked according to an increase or decrease in the area of the decal D2, so that the area that is not projected onto the object OBJ1 is increased or decreased in association therewith. Therefore, rendering of the decal D1 that is projected onto the object OBJ1 and whose area is increased or decreased in association therewith can be implemented by a simple process.

On the other hand, in the case in which the above conventional masking process is used, the rendering of the decal D1 that increases or decreases due to a dynamic change in the position, pose, and/or shape of the object OBJ2 requires a process of changing division of the surface (upper surface) of the object OBJ1 onto which the decal D1 is projected into meshes in order to control the presence or absence of application of the decal D1. In that case, it is necessary to calculate a change in the decal D1 due to a dynamic change in the object OBJ2 each time the change occurs, based on a change in a positional relationship associated with the motion and projection direction of the object OBJ2 located away from meshes, resulting in excessive processing load. As described above, in the present example, rendering can be performed in which the decal D1 is changed only by dynamically changing the blocking object with the same positional relationship with respect to the object OBJ2 maintained. Therefore, processing load is reduced compared to conventional masking processes, and flexible blocking can be set according to various dynamic changes of an object.

In addition, the dynamic changes in a decal and/or a blocking object based on a game process include dynamic enlargement or reduction in a virtual space. For example, a decal defined in a virtual space may be dynamically enlarged or reduced according to a change in the size of a decal projected onto a projection target. In addition, a blocking object arranged in a virtual space may be dynamically enlarged or reduced according to a change in the size of a virtual object associated with blocking of a decal.

In addition, the blocking object illustrated in FIGS. 8 to 11 is arranged perpendicularly to the projection direction of a decal. However, as illustrated in FIG. 12, the arrangement direction of a blocking object with respect to the projection direction of a decal is not limited to the perpendicular direction. As described above, when a decal and/or a blocking object are dynamically changed in a virtual space, the arrangement direction of the blocking object with respect to the projection direction of the decal may be dynamically changed.

In the present example, a blocking object that blocks the projection of a decal defined in a virtual space may be set in association with the decal. A blocking object associated with a decal prohibits projection or allows rendering with a reduced projection degree within a range blocked along the projection direction of the decal. Meanwhile, a blocking object that is not associated with a decal allows rendering without changing the projection degree, i.e., direct projection, even within a range blocked along the projection direction of the decal. If, for each decal, a blocking object associated therewith can thus be selected, a blocking object can be selected for each decal, depending on the projection position, projection direction, characteristics, and the like of the decal.

In the present example, a single blocking object may be associated with a plurality of decals. A blocking object associated with a plurality of decals prohibits projection or allows rendering with a reduced projection degree within a range blocked along the projection direction even when any of the plurality of decals is projected. If a blocking object associated with a plurality of decals can thus be set, the number of blocking objects arranged in a virtual space can be reduced, so that processing load in a rendering process using decals can be reduced.

In the present example, a single decal may also be associated with a plurality of blocking objects. When a plurality of blocking objects associated with a decal are arranged along the projection direction of the decal, rendering may be performed with the projection degrees of the blocking objects adjusted and combined. As an example, when the projection degrees of a plurality of blocking objects are adjusted and combined, a decal may be rendered with a reduced projection degree based on a value obtained by multiplying each α value.

Although, in the present example, blocking objects are a single planar object, blocking objects may have other shapes. For example, a blocking object may be configured by an object having another three-dimensional shape or a combination of a plurality of planar objects having different arrangement angles, depending on the shape of a virtual object involved with blocking. In addition, for blocking objects, determination different from the determination of a projection degree using a texture for which the α value is set can be performed. For example, determination based on a polygon as a simple shape in a blocking object may be prepared, and a projection degree may be determined.

Although, in the present example, an example is used in which a decal is subjected to parallel projection from a projection start position defined in a virtual space and is rendered, a decal may be subjected to perspective projection and may be rendered in a virtual space. In that case, the above projection box may be set using a shape such as a cone, elliptic cone, or pyramid formed by projection lines along which a defined decal is subjected to perspective projection, and the projection degree of each pixel may be determined along the projection line.

In addition, in the present example, an example is used in which a decal is projected onto a surface on the front side of an object as a projection target for the decal on which the projection of the decal is started along the projection direction of the decal (the side seen from the decal start position). In this case, the decal is not projected onto any of the surfaces of the object whose normal is not opposite the projection direction of the decal (i.e., a surface whose normal has an angle of more than 90° with respect to the projection direction, where the angle is 0° when the normal is exactly opposite the projection direction). In another example, a decal may also be projected onto a surface on the back side of the object decal in the projection direction (the side not seen from the decal start position). In that case, surfaces of the object as a projection target for a decal include not only surfaces on the front side seen from the decal start position, but also surfaces on the back side whose normal is not opposite the projection direction of the decal.

In addition, in the example, an example is used in which the intermediate range within which the α value set for the texture of a blocking object is 0<the α value<1 is set in the vicinity of a boundary between a range within which the α value=1, i.e., a decal is blocked, and a range within which the α value=0, i.e., a decal is not blocked. In another example, the intermediate range may be set at a region surrounded by a range within which the α value=1, i.e., a decal is blocked, or a range within which the α value=0, i.e., a decal is not blocked. In that case, various embodiments of a rendering process can be provided, including rendering in which a projected decal partially appears to leak, and rendering in a projected decal partially appears to be transparent.

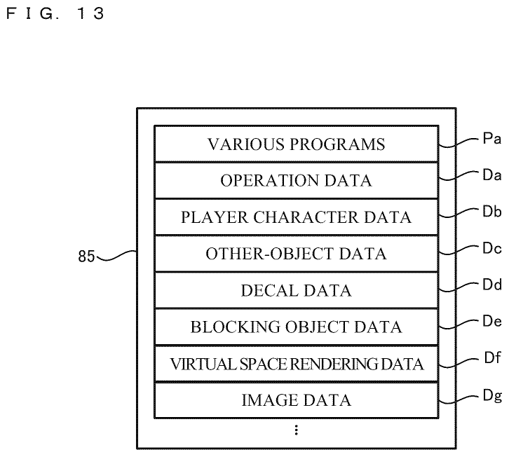

Next, an example of a specific process that is executed in the game system 1 will be described with reference to FIG. 13. It should be noted that in addition to the data of FIG. 13, the DRAM 85 also stores data used in other processes, which will not be described in detail.

Various programs Pa that are executed in the game system 1 are stored in a program storage area of the DRAM 85. In the present example, the programs Pa include an application program (e.g., a game program) for performing information processing based on data obtained from the left controller 3 and/or the right controller 4 and the main body apparatus 2, and the like. Note that the programs Pa may be previously stored in the flash memory 84, may be obtained from a storage medium removably attached to the game system 1 (e.g., a predetermined type of storage medium attached to the slot 23) and then stored in the DRAM 85, or may be obtained from another apparatus via a network, such as the Internet, and then stored in the DRAM 85. The processor 81 executes the programs Pa stored in the DRAM 85.

In addition, the data storage area of the DRAM 85 stores various kinds of data that are used in processes that are executed in the game system 1 such as information processes. In the present example, the DRAM 85 stores operation data Da, player character data Db, other-object data Dc, decal data Dd, blocking object data De, virtual space rendering data Df, image data Dg, and the like.

The operation data Da is obtained, as appropriate, from each of the left controller 3 and/or the right controller 4 and the main body apparatus 2. As described above, the operation data obtained from each of the left controller 3 and/or the right controller 4 and the main body apparatus 2 includes information about an input from each input section (specifically, each button, an analog stick, or a touch panel) (specifically, information about an operation). In the present example, operation data is obtained from each of the left controller 3 and/or the right controller 4 and the main body apparatus 2. The obtained operation data is used to update the operation data Da as appropriate. It should be noted that the operation data Da may be updated for each frame that is the cycle of a process executed in the game system 1, or may be updated each time operation data is obtained.

The player character data Db indicates the location, direction, and pose, and an action and state in the virtual space, of a player character located in the virtual space, and the like.

The other-object data Dc indicates the position, direction, pose, motion and state in a virtual space of each object arranged in the virtual space.

The decal data Dd indicates the details, projection position, projection direction, size, shape, projection box, and the like of each decal defined in the virtual space.

The blocking object data De indicates the position, direction, pose, size, shape, and set texture information (α value) of each blocking object arranged in the virtual space, and a decal associated with each blocking object.

The virtual space rendering data Df is for rendering the virtual space and displaying the rendered virtual space on a display screen.

The image data Dg is for displaying an image (e.g., an image of a player character, an image of each virtual object, an image of a decal, an image of a field of the virtual space, and a background image) on a display screen (e.g., the display 12 of the main body apparatus 2).

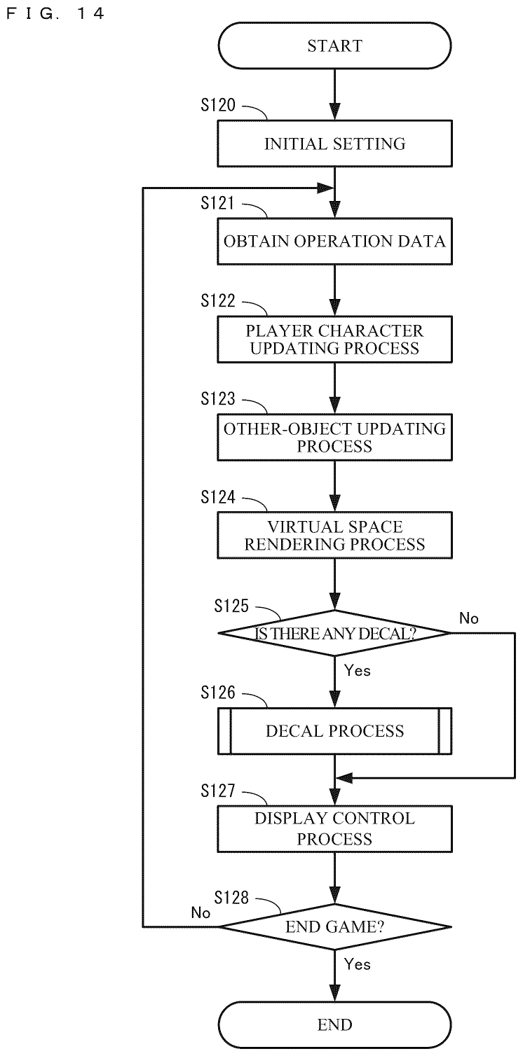

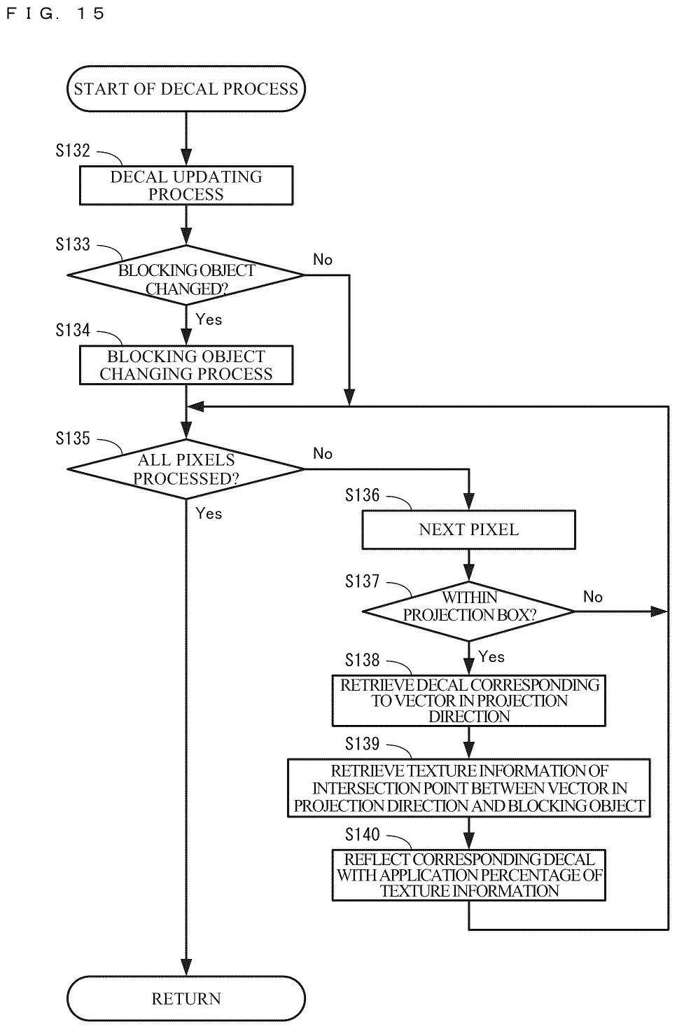

Next, a detailed example of a game process that is an example of an information process in the present example will be described with reference to FIGS. 14 and 15. In the present example, a series of steps illustrated in FIGS. 14 and 15 are executed by the processor 81 executing a predetermined application program (game program) included the programs Pa. The game process of FIGS. 14 and 15 is started with any appropriate timing.

It should be noted that the steps in the flowcharts of FIGS. 14 and 15, which are merely illustrative, may be executed in a different order, or another step may be executed in addition to (or instead of) each step, if a similar effect is obtained. In the present example, it is assumed that the processor 81 executes each step of the flowcharts. Alternatively, a portion of the steps of the flowcharts may be executed by a processor or dedicated circuit other than the processor 81. In addition, a portion of the steps executed by the main body apparatus 2 may be executed by another information processing apparatus that can communicate with the main body apparatus 2 (e.g., a server that can communicate with the main body apparatus 2 via a network). Specifically, the steps of FIGS. 14 and 15 may be executed by a plurality of information processing apparatuses including the main body apparatus 2 cooperating with each other.

In FIG. 14, the processor 81 executes initial setting for the game process (step S120), and proceeds to the next step. For example, in the initial setting, the processor 81 initializes parameters for executing processes described below, and updates each data. As an example, the processor 81 arranges a player character having a predetermined pose at a default position in the virtual space in the initial state, and updates the player character data Db. The processor 81 also generates the virtual space in the initial state by arranging various objects, other characters, and the like on a game field in the virtual space, and updates the other-object data Dc. The processor 81 also defines a decal and arranges a blocking object that is associated with the decal in the virtual space, and updates the decal data Dd and the blocking object data De.

Next, the processor 81 obtains operation data from the left controller 3, the right controller 4, and/or the main body apparatus 2, and updates the operation data Da (step S121), and proceeds to the next step.

Next, the processor 81 performs a player character updating process (step S122), and proceeds to the next step. For example, the processor 81 sets an action of a player character based on the operation data Da. As an example, the processor 81 sets the position, direction, pose, action, state, and the like of a player character based on the user's operation input indicated by the operation data Da, a virtual physical calculation in the virtual space, and the like, and updates the player character data Db.

Next, the processor 81 updates the positions and poses of various objects, other characters, and the like in the virtual space (step S123), and proceeds to the next step. As an example, when other objects and other characters are dynamically changed due to a player character's action, the processor 81 changes the objects and characters based on a player character's action updated in step S122, and updates the object data Dc with the changed positions and poses. As another example, when other objects and other characters are dynamically changed based on an environment such as a physical law in the virtual space, the processor 81 changes the objects and characters based on the environment, and updates the object data Dc with the changed positions and poses.

Next, the processor 81 performs a rendering process on the virtual space (step S124), and proceeds to the next step. For example, the processor 81 arranges a player character, various objects, other characters, and the like in the virtual space based on the player character data Db and the other-object data Dc. The processor 81 then generates an image of the virtual space as viewed from a virtual camera for generating a display image, renders the virtual space image, and updates the virtual space rendering data Df. It should be noted that the processor 81 may execute a process of controlling the movement of the virtual camera based on the position and pose of the player character. The processor 81 may also move the virtual camera in the virtual space based on the operation data Da.

Next, the processor 81 determines whether or not a decal has been defined in the virtual space (step S125). For example, the processor 81 looks up the decal data Dd, and proceeds to step S126 if a decal that is to be projected in the virtual space has been defined. Otherwise, i.e., if a decal that is to be projected in the virtual space has not been defined, the processor 81 proceeds to step S127.

In step S126, the processor 81 performs a decal process, and proceeds to step S127. The decal process in step S126 will be described below with reference to FIG. 15.

In FIG. 15, the processor 81 performs a decal updating process (step S132), and proceeds to the next step. In the decal updating process of step S132, the processor 81 changes the details, projection position, projection direction, size, shape, projection box, and the like of the decal into the most recent state, and updates the decal data Dd. Specifically, even when a change such as movement occurs in the decal, the change is reflected in the updating process.

Next, the processor 81 determines whether or not a blocking object has been changed in the virtual space (step S133). For example, if at least one object (e.g., the object OBJ2) involved with blocking of a decal has been changed based on the processes of steps S121 to S123 and an environment such as a physical law in the virtual space, the result of the determination by the processor 81 in step S133 is positive. If a blocking object has been changed in the virtual space, the processor 81 proceeds to step S134. Otherwise, i.e., if a blocking object has not been changed in the virtual space, the processor 81 proceeds to step S135.

In step S134, the processor 81 performs a blocking object changing process, and proceeds to step S135. For example, the processor 81 changes the position, direction, pose, size, shape, set texture, and the like of a blocking object associated with an object involved in the blocking according to a change in the object in the virtual space, and updates the blocking object data De.

In step S135, the processor 81 determines whether or not all pixels of interest have been processed, with reference to the virtual space rendering data Df. If not all pixels have been processed, the processor 81 proceeds to step S136. Otherwise, i.e., if all pixels have been processed, the processor 81 ends the process of the subroutine. It should be noted that the pixels of interest may be all pixels in the image of the virtual space rendered in step S124, or all pixels within a limited range for each decal. For example, the pixels of interest may be all pixels included within a range corresponding to a shape (a rectangular cuboid polygon or the like) including the projection region of each decal.

In step S136, the processor 81 chooses a pixel that has not been processed from all pixels in the image of the virtual space, with reference to the virtual space rendering data Df, and proceeds to the next step.

Next, the processor 81 determines, with reference to the decal data Dd, whether or not a pixel to be processed is arranged at a position included in any of the projection boxes of the decals defined in the virtual space (step S137). If a pixel to be processed is arranged in a projection box, the processor 81 proceeds to step S138. Otherwise, i.e., if a pixel to be processed is not arranged in any projection box, the processor 81 proceeds to step S135 and repeats the process.

In step S138, for the pixel to be processed, the processor 81 retrieves, from the decal data Dd, the decal corresponding to a vector in the projection direction of the decal for which a projection box in which the pixel is arranged is set, and proceeds to the next step.

Next, for the pixel to be processed, the processor 81 retrieves, from the blocking object data De, texture information (α value) of an intersection point between the vector in the projection direction and a blocking object corresponding to the decal (step S139), and proceeds to the next step.

Next, the processor 81 reflects the color, lightness, colorfulness, and the like of the decal retrieved in step S138, in the pixel to be processed, with an application percentage corresponding to the texture information (α value) retrieved in step S139, updates the virtual space rendering data Df (step S140), and returns to and repeats step S135.

Referring back to FIG. 14, in step S127, the processor 81 performs a display control process, and proceeds to the next step. For example, the processor 81 performs control to display an image of the virtual space on the display 12 with reference to the virtual space rendering data Df.

Next, the processor 81 determines whether or not to end the game process (step S128). In step S128, the game process is ended, for example, if a condition for ending the game process is satisfied, the user has performed an operation of ending the game process, or the like. If the processor 81 determines not to end the game process, the processor 81 returns to and repeats step S121. Otherwise, i.e., if the processor 81 determines to end the game process, the processor 81 ends the flowchart. Following this, steps S121 to S128 are repeatedly executed until the processor 81 determines to end the game process in step S128.

Thus, in the present example, a decal is blocked by arranging a blocking object at a portion through which the decal would otherwise penetrate to cause a trouble, whereby the decal can be prevented from penetrating through that portion and being then projected along the projection direction.

The game system 1 may be any suitable apparatus, including handheld game apparatuses, personal digital assistants (PDAs), mobile telephones, personal computers, cameras, tablet computers, and the like.

In the foregoing, the information process (game process) is performed in the game system 1 by way of example. Alternatively, at least a portion of the process steps may be performed in another apparatus. For example, when the game system 1 can also communicate with another apparatus (e.g., a server, another information processing apparatus, another image display apparatus, another game apparatus, another mobile terminal, etc.), the process steps may be executed in cooperation with the second apparatus. By thus causing another apparatus to perform a portion of the process steps, a process similar to the above process can be performed. The above information process may be executed by a single processor or a plurality of cooperating processors included in an information processing system including at least one information processing apparatus. In the above example, the information processes can be performed by the processor 81 of the game system 1 executing predetermined programs. Alternatively, all or a portion of the above processes may be performed by a dedicated circuit included in the game system 1.

Here, according to the above variation, the present example can be implanted in a so-called cloud computing system form or distributed wide-area and local-area network system forms. For example, in a distributed local-area network system, the above process can be executed by cooperation between a stationary information processing apparatus (a stationary game apparatus) and a mobile information processing apparatus (handheld game apparatus). It should be noted that, in these system forms, each of the steps may be performed by substantially any of the apparatuses, and the present example may be implemented by assigning the steps to the apparatuses in substantially any manner.

The order of steps, setting values, conditions for determination, etc., used in the above information process are merely illustrative, and of course, other order of steps, setting values, conditions for determination, etc., may be used to implement the present example.

The above programs may be supplied to the game system 1 not only through an external storage medium, such as an external memory, but also through a wired or wireless communication line. The program may be previously stored in a non-volatile storage device in the game system 1. Examples of an information storage medium storing the program include non-volatile memories, and in addition, CD-ROMs, DVDs, optical disc-like storage media similar thereto, and flexible disks, hard disks, magneto-optical disks, and magnetic tapes. The information storage medium storing the program may be a volatile memory storing the program. Such a storage medium may be said as a storage medium that can be read by a computer, etc. (computer-readable storage medium, etc.). For example, the above various functions can be provided by causing a computer, etc., to read and execute programs from these storage media.

While several example systems, methods, devices, and apparatuses have been described above in detail, the foregoing description is in all aspects illustrative and not restrictive. It should be understood that numerous other modifications and variations can be devised without departing from the spirit and scope of the appended claims. It is, therefore, intended that the scope of the present technology is limited only by the appended claims and equivalents thereof. It should be understood that those skilled in the art could carry out the literal and equivalent scope of the appended claims based on the description of the present example and common technical knowledge. It should be understood throughout the present specification that expression of a singular form includes the concept of its plurality unless otherwise mentioned. Specifically, articles or adjectives for a singular form (e.g., “a”, “an”, “the”, etc., in English) include the concept of their plurality unless otherwise mentioned. It should also be understood that the terms as used herein have definitions typically used in the art unless otherwise mentioned. Thus, unless otherwise defined, all scientific and technical terms have the same meanings as those generally used by those skilled in the art to which the present example pertain. If there is any inconsistency or conflict, the present specification (including the definitions) shall prevail.

Thus, the present example is applicable as an image process program, image processing system, image processing apparatus, image processing method, and the like that can prevent a decal from penetrating through a portion through which a decal would otherwise penetrate to cause a trouble or the like and being then rendered.

What is claimed is:

1. A non-transitory computer-readable storage medium having stored therein instructions that, when executed, cause one or more processors of an information processing apparatus to execute information processing comprising:
defining a decal having a set projection position and projection direction, and arranging a blocking object set for the decal, in a virtual space; and
in a process of rendering the virtual space, for a surface of a projection target related to the projection position and the projection direction,
avoiding projecting the decal, or projecting and rendering the decal with a reduced degree of projection, onto a range of the surface that is blocked by the blocking object along the projection direction, and
projecting and rendering the decal onto a range of the surface that is not blocked by the blocking object along the projection direction.

2. The non-transitory computer-readable storage medium according to claim 1, wherein
further, at least one of the projection position and projection direction of the decal is dynamically changed in the virtual space.

3. The non-transitory computer-readable storage medium according to claim 1, wherein
further, at least one of the position and shape of the blocking object is dynamically changed in the virtual space.

4. The non-transitory computer-readable storage medium according to claim 1, wherein
the blocking object is an object that is not a rendering target.

5. The non-transitory computer-readable storage medium according to claim 1, wherein
the blocking object is a planar object.

6. The non-transitory computer-readable storage medium according to claim 5, wherein
for the blocking object, a texture including an alpha value is set, and
further, in the process of rendering the virtual space, the decal is projected and rendered with a projection degree set according to the alpha value of the texture associated with a position on the blocking object that is blocked during the projection.

7. An image processing system comprising:
one or more processors; and
one or more memories storing instructions that, when executed, cause the image processing system to perform operations including:
defining a decal having a set projection position and projection direction, and arranging a blocking object set for the decal, in a virtual space; and
in a process of rendering the virtual space, for a surface of a projection target related to the projection position and the projection direction,
avoiding projecting the decal, or projecting and rendering the decal with a reduced degree of projection, onto a range of the surface that is blocked by the blocking object along the projection direction, and
projecting and rendering the decal onto a range of the surface that is not blocked by the blocking object along the projection direction.

8. The image processing system according to claim 7, wherein
further, at least one of the projection position and projection direction of the decal is dynamically changed in the virtual space.

9. The image processing system according to claim 7, wherein
further, at least one of the position and shape of the blocking object is dynamically changed in the virtual space.

10. The image processing system according to claim 7, wherein
the blocking object is an object that is not a rendering target.

11. The image processing system according to claim 7, wherein
the blocking object is a planar object.

12. The image processing system according to claim 11, wherein
for the blocking object, a texture including an alpha value is set, and
further, in the process of rendering the virtual space, the decal is projected and rendered with a projection degree set according to the alpha value of the texture associated with a position on the blocking object that is blocked during the projection.

13. An image processing apparatus comprising:
one or more processors; and
one or more memories storing instructions that, when executed, cause the image processing apparatus to perform operations including:
defining a decal having a set projection position and projection direction, and arranging a blocking object set for the decal, in a virtual space; and
in a process of rendering the virtual space, for a surface of a projection target related to the projection position and the projection direction,
avoiding projecting the decal, or projecting and rendering the decal with a reduced degree of projection, onto a range of the surface that is blocked by the blocking object along the projection direction, and
projecting and rendering the decal onto a range of the surface that is not blocked by the blocking object along the projection direction.

14. The image processing apparatus according to claim 13, wherein
further, at least one of the projection position and projection direction of the decal is dynamically changed in the virtual space.

15. The image processing apparatus according to claim 13, wherein
further, at least one of the position and shape of the blocking object is dynamically changed in the virtual space.

16. The image processing apparatus according to claim 13, wherein
the blocking object is an object that is not a rendering target.

17. The image processing apparatus according to claim 13, wherein
the blocking object is a planar object.

18. The image processing apparatus according to claim 17, wherein
for the blocking object, a texture including an alpha value is set, and
further, in the process of rendering the virtual space, the decal is projected and rendered with a projection degree set according to the alpha value of the texture associated with a position on the blocking object that is blocked during the projection.

19. An image processing method for causing one or more processors of an information processing system to at least:
define a decal having a set projection position and projection direction, and arrange a blocking object set for the decal, in a virtual space; and
in a process of rendering the virtual space, for a surface of a projection target related to the projection position and the projection direction,
avoid projecting the decal, or project and render the decal with a reduced degree of projection, onto a range of the surface that is blocked by the blocking object along the projection direction, and
project and render the decal onto a range of the surface that is not blocked by the blocking object along the projection direction.

20. The image processing method according to claim 19, wherein
further, at least one of the projection position and projection direction of the decal is dynamically changed in the virtual space.

21. The image processing method according to claim 19, wherein
further, at least one of the position and shape of the blocking object is dynamically changed in the virtual space.

22. The image processing method according to claim 19, wherein
the blocking object is an object that is not a rendering target.

23. The image processing method according to claim 19, wherein
the blocking object is a planar object.

24. The image processing method according to claim 23, wherein
for the blocking object, a texture including an alpha value is set, and
further, in the process of rendering the virtual space, the decal is projected and rendered with a projection degree set according to the alpha value of the texture associated with a position on the blocking object that is blocked during the projection.
